(19) United States
(12) Patent Application Publication
(10) Pub. No.: US 2007/0088983 A1
(43) Pub. Date: Apr. 19, 2007

(54) Integrated circuit comprising a measurement unit for measuring utlization

(75) Inventors: Abraham Karel Riemens, Eersel (NL); Josephus Theodorus Johannes Van Eijndhoven, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/577,536

(22) PCT Filed: Oct. 20, 2004
(86) PCT No.: PCT/IB04/52149

§ 371 Date: Apr. 26, 2006

(30) Foreign Application Priority Data
Oct. 27, 2003 (EP) 03103968.8

(51) Int. Cl. G06F 11/00

(52) U.S. Cl. 714/30

(57) ABSTRACT

The invention provides an integrated circuit comprising a data processing system which performs satisfactorily after integration of the individual building blocks, such as main processors and coprocessors, into the data processing system. This is achieved by measuring the utilization of the communication structure established between the individual building blocks. A measurement unit measures properties of the communication load by observing the communication traffic on connections between processing units and a communication resource, or on connections within the communication resource. The measurement unit performs statistical operations on the observed properties and produces measurement results. The measurement results can be retrieved by measurement software and can be used to modify the data processing system, for example by debugging or by adaptive control.

The invention relates to an integrated circuit comprising a data processing system, the data processing system comprising a plurality of processing units and a resource shared by at least two of the processing units. The invention also relates to a video processing unit comprising such an integrated circuit.

Data processing systems on integrated circuits, also referred to as systems-on-silicon, are often deployed in multimedia applications. For example, image or video processing units can be put together in a data processing system to obtain a complete image or video processing system. Such a data processing system usually comprises one or more central processing units (CPU's) and a number of dedicated processing units, for example image processing units. A CPU then manages the tasks that must be performed by the system, performs general tasks and controls the overall behavior of the system; this CPU is referred to as the control CPU. The dedicated processing units take input from the control CPU, perform specific image processing tasks and return their output to the control CPU. The dedicating processing units are also referred to as coprocessors. Other CPU's can be involved in performing computation tasks, also synchronizing their progress with the control CPU.

An embodiment of a data processing unit on an integrated circuit is given in U.S. Pat. No. 5,287,511, wherein architectures and methods are disclosed for dividing a processing task into tasks for a decision-making microprocessor and tasks for a programmable real-time signal processor. Another embodiment of such a data processing unit is disclosed in the article “Viper: A Multiprocessor SOC for Advanced Set-top Box and Digital TV Systems”, by Santanu Dutta, Rune Jensen and Alf Rieckmann, IEEE Design and test of computers, September/October 2001.

Data processing systems on integrated circuits also comprise a communication resource which is shared by the processing units, for example a shared bus. The communication resource may also be a crossbar switch, a hierarchical system with caches on different levels, or a network comprising routers. A shared memory typically acts as a central repository for data which flows between the processing units. In the example above, the CPU allocates buffers in the shared memory and it programs proper parameters into the image processing units for the task to be performed, including setup of the addresses of the buffers to be used. After initiating the execution, the image processing units autonomously retrieve the image data from the buffer in the shared memory, perform their processing tasks and store the results into an output buffer in the shared memory. The results of an image processing unit can be used by another image processing unit, by a CPU or they can be sent to the system output.

In a data processing system with a shared memory bus utilization and bus bandwidth are very important. In order to optimize the efficiency of the system, interaction with the shared memory is usually performed in bus transfers of 64 or 128 bytes of consecutive data. In this manner, the memory addressing needs only to be done for the whole transfer instead of for single data items. Furthermore, the whole system can be pipelined and the bus protocol can be decoupled from specific system choices like the total memory bandwidth. For example, the shared memory may be a single data rate SDRAM or a double data rate SDRAM without affecting the bus protocol.

Variations of the data processing system as set forth are possible. The data bus may be a network, consisting of a hierarchy of buses coupled via hubs or routers. In such a hierarchy of buses caching may be applied at various levels. Furthermore, the shared memory may be on-chip, off-chip or a mix of both, and it typically entails a set of physically distributed on-chip memory blocks.

Besides the shared memory, other elements of the data processing system may be shared amongst multiple tasks. For example, one or more central processing units (CPU's) execute a multitude of software programs, and the coprocessors can process multiple streams of data under the control of the CPU's. As mentioned before, the bus is shared by CPU's and coprocessors. For sharing of the CPU's and tracing of task switching many techniques are known, since most CPU's support multitasking operating systems that facilitate such tracing. According to the state of the art, the activity of the coprocessors in a multi-processor system can also be traced, usually by instrumentation of control software.

It has been found that a data processing system on an integrated circuit may not perform satisfactorily, even though the performance of individual building blocks of the system such as CPU's, coprocessors and memory units, is properly designed. The analysis of the system performance, in particular analyzing the cause of unsatisfactory performance at certain periods in time, has been found to be extremely difficult. Proper system performance analysis is however required for dynamic system control that aims at real-time guarantees on system response.

It is an object of the invention to provide an integrated circuit comprising a data processing system performing satisfactorily after integration of the individual building blocks into the data processing system. In order to achieve said object the integrated circuit is characterized by the characterizing part of claim 1.

The invention relies on the perception that the performance of the data processing system does not solely depend on the performance of the individual building blocks (processing units, memory units, etc.), but also on the communication structure of the data processing system. In large and complex data processing systems on integrated circuits, the communication structure is an important constituent of the overall system. Especially in these systems, the communication structure is increasingly becoming the main performance bottleneck. In order to increase the performance of the data processing system, a development approach must be used that takes into account the performance of the communication structure.

In the data processing system according to the invention, the communication structure is equipped with measurement units. These measurement units gather performance-related data from the communication structure by observing properties of the communication load on communication channels and by performing statistical operations on these properties. In this way, performance-related measurement results are obtained. The software developer, writing programs for the various components of the data processing system, can then read the measurement results and use them for optimizing the programs. Specifically, the effect of the program on the utilization of the communication structure can be varied and optimized. Additionally, the performance-related data can be used to dynamically modify system and task parameter settings, in order to improve the real-time behavior of the data processing system. An additional aspect of the invention is that measurement software can be installed on one of the processing units or on a control processor, which allows the software developer to retrieve the measurement data from the measurement units and supports him in interpreting the measurement data.

An additional advantage of the integrated circuit and the method according to the invention is that software development and debugging of software during the development process are facilitated. The software engineer can use the measurement data, which reflect the utilization of shared communication resources in the data processing system, to improve and to fine-tune the software that runs on the processing units. An improved software development process will lead to a shorter time-to-market of software products, a predictable development time and more efficient systems.

It is noted that WO 02/28027 discloses a method for fair data transfer in a shared bus by means of a distributed arbitration algorithm. The method aims at obtaining a fairly shared use of resources among the modules of a system under traffic-jam conditions. The method employs a distributed arbitration algorithm that can be implemented on both hardware and software of the different modules of the system and/or on the hardware mechanism involved in the arbitration on the shared bus. The access of data produced by the modules to the shared bus is weighted, and the weight relating to each module/data flow is being monitored through tags. Although this method provides a mechanism for weighted access to a shared bus by modules of the data processing system, by keeping track of granted accesses to the shared bus and by (re)prioritizing new accesses, it does not provide means to analyze the utilization of the bus during those accesses.

An embodiment of the integrated circuit is defined in claim 2, wherein a measurement unit measures the properties of the communication load by observing the communication traffic on a connection between a processing unit and the communication resource. Another embodiment is defined in claim 3, wherein the measurement unit measures the properties of the communication load by observing the communication traffic on a connection between parts of the communication resource. Depending on circumstances, one of the two approaches can be used or a combination of both.

In the embodiment according to claim 4, a measurement controller comprised in the measurement unit performs the statistical operations on the observed properties and stores the results in a plurality of measurement data buffers.

Depending on circumstances, it may be useful to distinguish different classes of communication traffic and to measure properties of the communication load for one or more of these classes. In that case the embodiment according to claim 5 is advantageous; the measurement controller is arranged to partition the properties of the communication load into distinct classes and to perform the statistical operations on at least one of the distinct classes separately. Examples of such classes are instruction-traffic classes and data-traffic classes.

A further embodiment of the integrated circuit is defined in claim 6. This embodiment is particularly advantageous if the dynamic behavior of the data processing system should be analyzed, for example in a situation with a CPU performing multiple tasks. The measurement controller is arranged to perform statistical operations on the properties of the communication load over units of time; these units form part of the time interval over which statistics are generated. The measurement controller produces a statistic, for example a minimum, maximum or average value, for each unit of time. In this manner a trace over time can be generated.

Claim 7 defines an embodiment comprising a control processor which is arranged to communicate with the measurement controller, wherein the measurement controller is equipped with a program (measurement software). The program can be deployed to configure the measurement unit. Claim 8 defines a further embodiment, wherein the program can be deployed to retrieve the measurement results from the measurement unit. The program according to claim 9 can also be used to enable the control processor to control the operation of the communication resource or the operation of the processing units. In this manner adaptive control can be implemented.

Claims 10, 11 and 12 specify various properties of the communication load which can be measured by the measurement unit. The measurement unit according to claim 10 is arranged to measure the amount of data transferred over a connection. The measurement unit according to claim 11 is arranged to measure the latency of a request for data transfer to the resource. The measurement unit according to claim 12 is arranged to measure the data transfer time for such a request.

The embodiment according to claim 13 provides a number of statistical operations on the observed properties, which can be performed by the measurement unit. Among others, it is possible to provide an average value of the observed properties, a minimum value of the observed properties or a maximum value of the observed properties. It is also possible to generate a histogram with occurrence rates of the values of the observed properties, as defined in claim 14.

The integrated circuit according to the invention can be advantageously deployed in a video processing unit, such as a set-top box, DVD recorder or a TV, as defined in claim 15. The video processing unit can be produced at a lower cost while its quality can be maintained.

The present invention is described in more detail with reference to the drawings, in which:

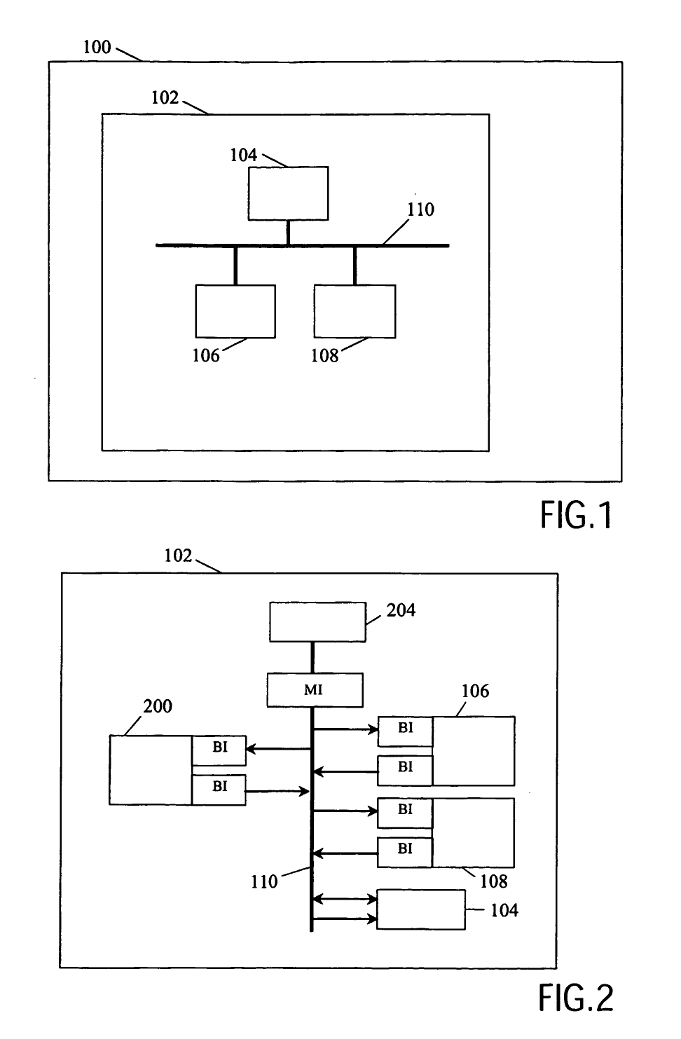

FIG. 1 illustrates an integrated circuit comprising a data processing system, which comprises a plurality of processing units and a communication resource shared by the processing units;

FIG. 2 illustrates an example of a data processing system as shown in FIG. 1;

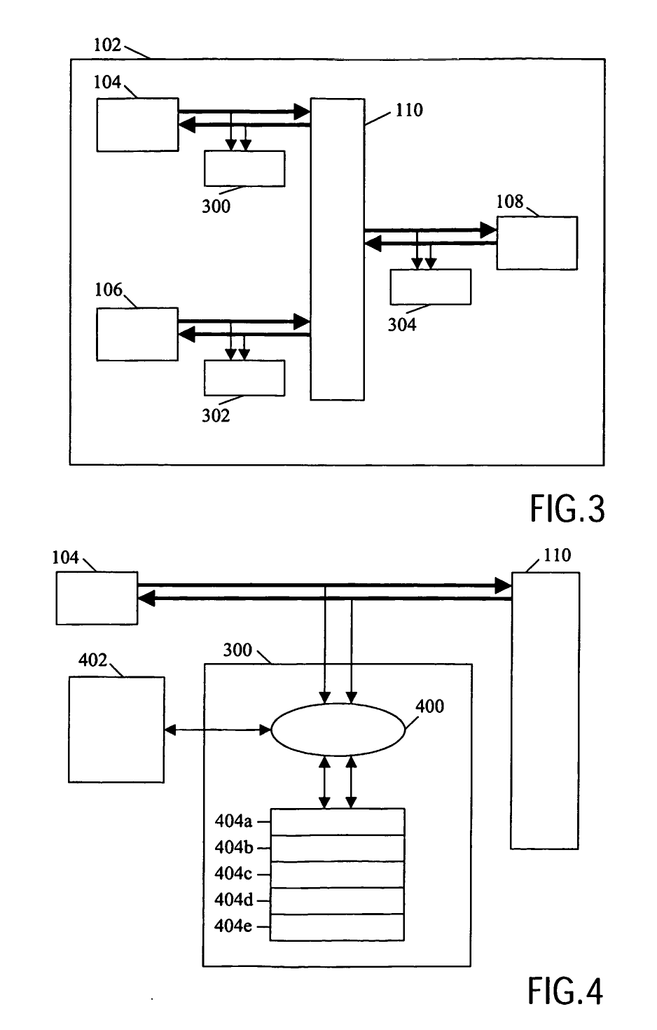

FIG. 3 illustrates a data processing system according to the invention;

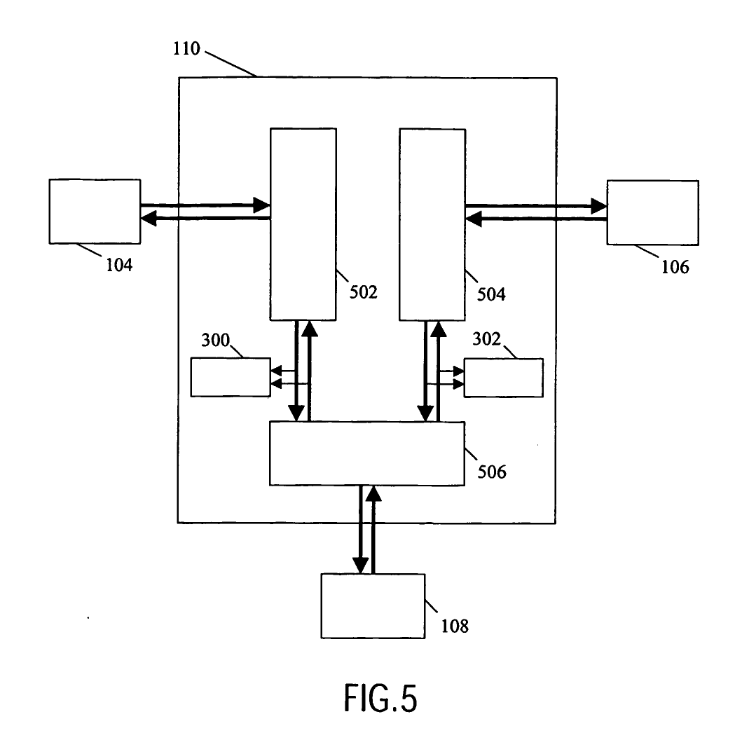

FIG. 4 illustrates a measurement unit according to the invention;

FIG. 5 illustrates a communication resource according to the invention.

FIG. 1 illustrates an integrated circuit 100 comprising a data processing system 102 comprising a plurality of processing units 104, 106, 108 and a communication resource 110 shared by the processing units. The communication resource 110 is for example a bus. The processing units 104, 106, 108 may comprise one or more central processing units (CPU's) which perform general tasks and control the realization of tasks, supporting an operating system which is suited for multitasking. The processing units 104, 106, 108 may also comprise one or more dedicated processing units, also referred to as coprocessors, which perform specific tasks such as processing of image or video data streams. The CPU's communicate with other CPU's or with coprocessors through the communication resource, which is typically implemented as a bus.

FIG. 2 illustrates an example of a data processing system as shown in FIG. 1. A data processing system 102 comprises a CPU 104 and two coprocessors 106, 108, which correspond to the processing units as shown in FIG. 1. The CPU 104 and the coprocessors 106, 108 communicate through a bus 110. Additionally, another coprocessor 200 is provided, as well as a memory unit 204 which is shared by the processing units 104, 106, 108, 200 and a memory interface MI which is deployed as an interface between the memory unit 204 and the bus 110. In this example, the memory unit 204 is on-chip, but it is also possible to have an off-chip memory unit. The coprocessors 106, 108, 200 comprise bus interfaces BI which are deployed as interfaces between the coprocessors and the bus 110. The bus 110 includes an arbiter component (not shown) which arbitrates the requests for bus access from the processing units 104, 106, 108, 200.

In such a data processing system, the CPU 104 typically allocates buffers in the memory unit 204 and it programs proper parameters into the coprocessors 106, 108, 200 for the tasks to be performed. This includes the setup of the addresses of the buffers which should be used. After initiating the execution, the coprocessors autonomously retrieve their input data from the buffer in the memory unit 204, perform their processing and store the results into an output buffer in the memory unit 204. System input data is typically retrieved from outside (not shown). The results produced by a coprocessor can be used by another coprocessor, by the CPU 104 or sent to the system output (not shown). In this data processing system, which is also referred to as a shared memory system, bus utilization and bus bandwidth are very important.

In order to optimize the efficiency of the shared memory system, interaction of the processing units 104, 106, 108, 200 with the memory unit 204 is typically performed in bus transfers of 64 or 128 bytes of consecutive data. The length of such a bus transfer is also referred to as the burst length or the size of a data packet; the length may vary according to the size of the data which should be transferred. For small data the data packet is preferably small as well, since otherwise a large part of the packet will not be used. For reducing the penalty of the bus protocol, the size of data packets should be as large as possible, so the size of data packets should be chosen properly.

If bus transfers are used, then addressing the memory needs only to be done once for the whole transfer and the penalty of the bus protocol in terms of cycle delay is reduced. However, the efficiency of this shared memory system not only depends on the efficiency of the individual processing units 104, 106, 108, 200 and their addressing mechanism, or the efficiency of the memory unit 204 taken separately, but also on the efficient utilization of the bus, which forms the communication structure between the processing units and the memory unit. Furthermore, the overall system performance depends on the scheduling of the individual tasks as their communication requirements may vary dynamically. This aspect is rarely taken into account during software development and debugging, although it may have a major impact on the performance of the overall system. There are methods and architectures which aim at keeping track of granted accesses to the bus by a certain processing unit, in the sense that the priority of the processing unit to get access to the bus increases or decreases depending on the number of granted accesses. However, the load imposed on a communication resource by the processing units is not measured.

FIG. 3 illustrates a data processing system according to the invention. The data processing system 102 again comprises processing units 104, 106, 108 and a communication resource 110 shared by the processing units. In this case, the communication resource 110 is a bus equipped with an arbiter (not shown) which is capable of prioritizing requests between the various processing units. The data processing system 102 is further equipped with measurement units 300, 302, 304 which measure properties of the communication load imposed on the communication resource 110 by the processing units 104, 106, 108. Specifically, the measurement units comprise in this example:

a measurement unit 300 to measure the communication load between a first processing unit 104 and the bus 110;

a measurement unit 302 to measure the communication load between a second processing unit 106 and the bus 110;

a measurement unit 304 to measure the communication load between a third processing unit 108 and the bus 110.

In the arrangement illustrated in FIG. 3, the measurement units 300, 302, 304 are coupled to the communication channels between the processing units 104, 106, 108 and the bus 110. Alternatively, the measurement units may be comprised in the communication resource to analyze the utilization of channels within the communication resource itself, as will be explained with reference to FIG. 5. In that case, the measurement units are preferably located near the ‘bottlenecks’ of the communication resource, i.e. locations in the communication infrastructure for which it is expected that performance-related problems occur.

Examples of measurement information which can be retrieved are:

the amount of data transferred over the communication resource 110 from and to a processing unit 104, 106, 108 in a unit of time;

the latency of a request for data transfer to the communication resource 110, defined as the time that elapses between the moment of request for data transfer (by a processing unit 104, 106, 108) and the moment of granting bus access by the arbiter;

the data transfer time of a request for data transfer, defined as the time that elapses between the moment of granting bus access by the arbiter and the moment that the data transfer has finished and the bus occupation ends.

These examples are not exhaustive. Depending on the specific nature of the data processing system and its communication structure, it may be advantageous to obtain other measurement data.

According to an aspect of the invention the measurement unit measures properties of the communication load imposed on a communication resource by a processing unit, by observing the communication traffic on a connection between the communication resource and the processing unit. According to another aspect of the invention, the measurement unit may also measure the properties of the communication load by observing the communication traffic on a connection within the communication resource, i.e. between different parts of the resource. For example, within a resource comprising a hierarchy of buses it may be useful to observe the communication traffic between the buses.

The measurement unit is able to generate measurement results which can be stored and later retrieved by software or deployed otherwise. These measurement results are the output of statistical operations on the observed properties of the communication load in a certain time interval. The statistical operations are preferably performed by a measurement controller and the measurement results are stored in buffers, for example in internal registers of the measurement unit. Statistical operations may for example provide a minimum or maximum value of the observed properties, an average value or a complete histogram with occurrence rates of all values.

An additional aspect of the invention is that a trace over time can be generated. For this purpose, the time interval is divided into a plurality of units and the measurement controller can perform statistical operations on the properties of the communication load over each unit. For example, the result may be a trace of average values of the observed properties. A trace over time allows an analysis of the correlation of the communication load with the activity of the system, but it requires a larger buffer to store the information before it can be retrieved by measurement software.

It is also possible to categorize the properties of the communication load into classes. In this manner several types of traffic can be distinguished; for example traffic containing instructions can be distinguished from traffic containing data. Other classification criteria may distinguish between communication peers (e.g. whether the target is on-chip or off-chip) or distinguish read from write traffic. Classes can also be discriminated from each other by checking whether the value of the addresses associated with the bus transfer belongs to particular address ranges. In a preferred embodiment, the values of the bounds of the address ranges that correspond to measurement classes of interest are stored locally in registers in the measurement unit, and their value is configured through measurement software. The statistics can be calculated separately for each communication class. If data traces are collected, the classification may be stored as part of trace samples. When traces of measurements over time are collected, these will typically consist of statistics of the load on the communication resource. The statistics are then collected over time slots, which are significantly smaller than the duration of the trace itself.

The measurement results can be stored at different places, for example:

in a local buffer in hardware within or close to a measurement unit, which is suitable for small amounts of measurement data;

in a background memory or a shared memory, which is suitable for larger amounts of data, but this increases the bandwidth requirements of the memory.

The measurement units can be implemented by hardware at various locations in the architecture of the data processing system, for example at a bus interface.

Once the measurement results are available, then the programmer can retrieve them via a program (measurement software) and use them for debugging and further development. Alternatively, the measurement results can be used by the control CPU to automatically modify system and task parameter settings, with the objective to improve the real-time behavior of the data processing system.

Those skilled in the art will appreciate that the amount of data required for the measurements is typically some orders of magnitude smaller than the communication load that is being monitored. As a result, storage and handling of the measurement results will only add marginal cost to the system. Furthermore, even when the measurement results are communicated via the communication resource that is observed by the measurement unit, the effect of the additional measurement communication load on the total system operation is marginal. This results in virtually non-intrusive real-time measurement. Alternatively, dedicated measurement storage, communication and analysis means may exist in the system to facilitate pure non-intrusive real-time system observation.

FIG. 4 illustrates a measurement unit according to the invention. In this example, the measurement unit 300 measures the communication load between a processing unit 104 and the bus 110. The measurement unit 300 comprises a measurement controller 400 which is arranged to perform the statistical operations on the observed properties of the communication load imposed on the resource 110 by the processing unit 104; in this manner the measurement controller 400 produces various measurement results. The measurement controller 400 further controls the use of measurement data buffers 404a, 404b, 404c, 404d, 404e (implemented as internal registers) to store the various measurement results. The measurement controller 400 interacts with a control processor 402 which is external to the measurement unit 300.

The control processor 402 is equipped with measurement software that can configure the measurement unit 300. It is noted that the measurement software may comprise a single program, a plurality of interacting modules or a collection of independent programs. The measurement software can also retrieve the measurement results produced by the measurement unit 300. Alternatively, the measurement software can be installed on a processing unit 104 or any other CPU in the system. In another embodiment, the measurement software can also control the operation of the communication resource 110, for example by modifying the settings of the arbiter. Alternatively, the measurement software can control the operation of the processing unit 104 or any other processing unit in the system, for example by rescheduling software tasks (changing the priority of operating system tasks) or by decreasing the quality of software and/or hardware functions to reduce resource utilization. The measurement data can be retrieved via the communication structure of the data processing system or via an independent communication channel/resource. The control processor 402 may further be configured to automatically modify system and task parameter settings, instead of a processing unit 104 being configured for this purpose.

FIG. 4 depicts an embodiment wherein the measurement unit 300 merely observes the bus connection between the processing unit 104 and the bus 110. This is a preferred embodiment since the measurement unit 300 does not influence the behavior of the data processing system. However, a different embodiment (not shown) may use a measurement unit which is coupled directly to the processing unit and the bus. The communication between the processing unit and the bus then passes through the measurement unit. Such an embodiment can be beneficial to obtain better or faster implementations. Furthermore, such an embodiment allows the measurement unit to become integrated as part of (for example) a bus protocol adapter unit.

FIG. 5 illustrates a communication resource 110 according to the invention; the example shown is a bus system comprising a plurality of buses 502, 504, 506 and connections between the buses. In this case, the processing units 104, 106, 108 do not only impose a communication load on the connections between themselves and the buses 502, 504, 506, but also on the connections between the buses 502 and 506, respectively the buses 504 and 506. Measurement units 300, 302 can be arranged to observe the properties of the communication load on these connections; the same statistics can be produced as for the connections between the processing units 104, 106, 108 and the buses 502, 504, 506.

The integrated circuit of the invention can be advantageously deployed in video processing units such as a set-top boxes, DVD recorders, TV's etc. The integrated circuit provides the same reliability and quality at a lower cost, so the video processing units are cheaper to produce while the same quality can be guaranteed.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. An integrated circuit comprising a data processing system the data processing system comprising a plurality of processing units and a resource shared by at least two of the processing units characterized by at least one measurement unit the measurement unit being arranged to measure properties of the communication load imposed on the resource by the processing units over a time interval, the measurement unit also being arranged to perform statistical operations on the properties of the communication load, wherein the statistical operations provide measurement results.

2. An integrated circuit as claimed in claim 1, wherein the measurement unit measures the properties of the communication load by observing the communication traffic on a first connection, the first connection being established between a processing unit and the resource

3. An integrated circuit as claimed in claim 1, wherein the measurement unit measures the properties of the communication load by observing the communication traffic on a second connection, the second connection being established between parts of the resource

4. An integrated circuit as claimed in claim 1, wherein the measurement unit comprises a measurement controller and a plurality of measurement data buffers, the measurement controller being arranged to perform the statistical operations and to store the measurement results in the measurement data buffers

5. An integrated circuit as claimed in claim 4, wherein the measurement controller is further arranged to partition the properties of the communication load into distinct classes and to perform the statistical operations on at least one of the distinct classes separately.

6. An integrated circuit as claimed in claim 4, the time interval being divided into a plurality of units, wherein the measurement controller is further arranged to perform statistical operations on the properties of the communication load over each unit and to provide the measurement results as a trace over time.

7. An integrated circuit as claimed in claim 4, wherein the measurement controller is further arranged to communicate with a control processor the control processor being equipped with a program, the program being conceived to configure the measurement unit

8. An integrated circuit as claimed in claim 7, wherein the program is further conceived to enable the control processor to retrieve the measurement results from the measurement unit

9. An integrated circuit as claimed in claim 7, wherein the program is further conceived to enable the control processor to control the operation of the resource or to control the operation of the processing units

10. An integrated circuit as claimed in claim 2, wherein the measurement unit is arranged to measure the amount of data transferred over the first connection or over the second connection, the amount of data transferred being one of the properties of the communication load.

11. An integrated circuit as claimed claim 2, wherein the measurement unit is arranged to measure the latency of a request for data transfer to the resource over the first connection or over the second connection, the latency of a request for data transfer being one of the properties of the communication load.

12. An integrated circuit as claimed in claim 2, wherein the measurement unit is arranged to measure the data transfer time to the resource over the first connection or over the second connection, the data transfer time being one of the properties of the communication load.

13. An integrated circuit as claimed in claim 1, wherein the statistical operations comprise average operations, minimum operations or maximum operations.

14. An integrated circuit as claimed in claim 1, wherein the statistical operations comprise operations creating a set of values constituting a histogram with occurrence rates.

15. A video processing unit comprising an integrated circuit as claimed in claim 1.
